(19) United States
(12) Patent Application Publication
(10) Pub. No.: US 2012/0310997 A1
(43) Pub. Date: Dec. 6, 2012

(54) CUSTOMIZING LANGUAGE FOR ORGANIZATION APPLICATION INSTALLATION

(75) Inventors: Agustin Da Fieno Delucchi, Bellevue, WA (US); Michael Ott, Redmond, WA (US); Chris Shoring, Sammamish, WA (US); Elliot Lewis, Bellevue, WA (US); Nabanita Majumdar, Snoqualmie, WA (US); Atul Shenoy, Seattle, WA (US); Matios Bedrosian, Bothell, WA (US)

(73) Assignee: MICROSOFT CORPORATION, Redmond, WA (US)

(21) Appl. No.: 13/152,739

(22) Filed: Jun. 3, 2011

(51) Int. Cl. G06F 17/30

(52) U.S. Cl. 707/811; 707/E17.127

(57) ABSTRACT

A customer relationship management (CRM) application provides a user interface to detect language selection and create a default organization application using the selected language. The CRM application can enable a user to configure a subsequent organization application utilizing settings inherited from the default organization application. The CRM application can further enable the user to provide a second base language selection for the subsequent organization application installation and create the second organization application according to the language selection in hosted and/or on-premise environments.

### BACKGROUND

With the proliferation of networking and network based processing, web based services and web applications are taking over the traditional computing tasks performed by locally installed applications. Locally installed applications, as their name suggests, need to be installed, maintained, and updated at the local level making it difficult to manage larger systems such as enterprise computing systems, where hundreds or thousands of users need attention and support of the information technology personnel. Maintenance cycles, upgrade costs, personnel training, etc. have associated costs burdening a business for continued productivity while employing local applications.

Modern enterprise systems provide businesses with application management solutions. Application management solutions provide business users with customizable applications to meet business demands. Variety of solutions from document management to inventory management may be customized and/or integrated to serve business-specific needs. Centrally hosted application management also simplifies information technology (IT) resource management while minimizing personnel cost/time. An unmet area of customization in modern application management solutions is providing language specific application solutions tailored to meet business needs of customers.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to an application management system customizing language for an organization application. The application management system may detect a default base language selection and create a default organization application using the selected language. Upon configuring a second organization application using the default settings, the application management system may detect a second base language selection and create the second organization application using the selected second base language based on a plurality of available language packages in hosted and/or on-premise environments.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates a networked environment, where an application manager may customize language for an organization application according to some embodiments;

FIG. 2 illustrates example actions and components for customizing language for an organization application;

FIG. 3 illustrates a screenshot of an example interface with configurable components for customizing organization application language;

FIG. 4 illustrates another screenshot of an example interface configuring language for an organization application;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process customizing language of an organization application according to embodiments.

### DETAILED DESCRIPTION

As briefly described above, an application management system may customize language for an organization application at installation. An organization application may be a custom application tailored to meet business demands. The application management system may detect a default base language selection and create a default organization application using the selected language. Subsequent organization applications may be configured using the default organization application's settings to meet language demands of the business using another base language upon detecting selection of a different base language. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a non-transitory computer-readable memory device. The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for customizing language for an organization application. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

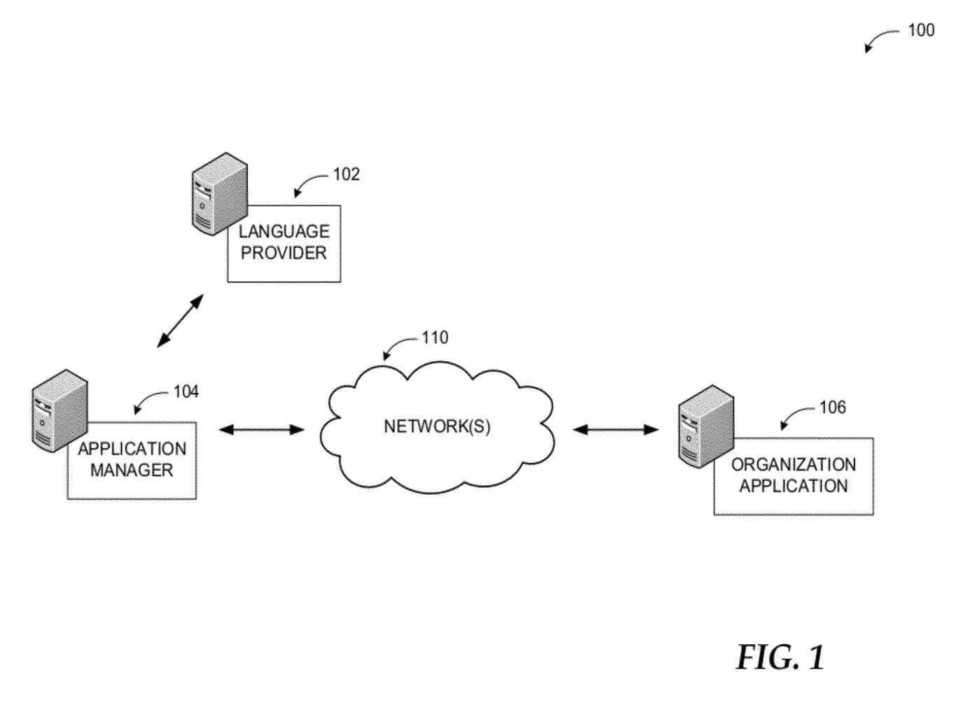

Referring to FIG. 1, diagram 100 illustrates a networked environment, where an application manager may customize language for an organization application according to some embodiments. The computing devices and computing environments shown in diagram 100 are for illustration purposes. Embodiments may be implemented in various local, networked, and similar computing environments employing a variety of computing devices and systems.

In an example environment illustrated in diagram 100, a server may host an application manager 104. The application manager 104 may be, for example, a customer resource management (CRM) application. The application manager 104 may enable users to install business specific applications such as an organization application 106 on one or more servers. The organization application 106 may be a custom application built by the application manager 104 to serve business needs of a customer. The organization application 106 may exist at customer site and provided through a customer server (on-premise environment). Alternatively, the organization application 106 may be provided as a hosted service remotely to clients via network(s) 110.

In an embodiment, the organization application's language may be customized by the application manager during installation or later configuration. The application manager 104 may provide language options according to local language resources. Alternatively, the application manager 104 may retrieve language resources from an external provider such as language provider 102. Language provider 102 may be a separate component of a service providing application manager 104 (among other things) or a third party provider and offer languages to customize the organization application 106. An example may be language packs containing languages for a world region, where the application manager is licensed to operate. In another example, the language provider 102 may be installation media such as installation disks containing language packs to be provided to the application manager 104 upon demand. Embodiments are not limited to client/server architectures and may be deployed using other architectures such as peer-to-peer, etc.

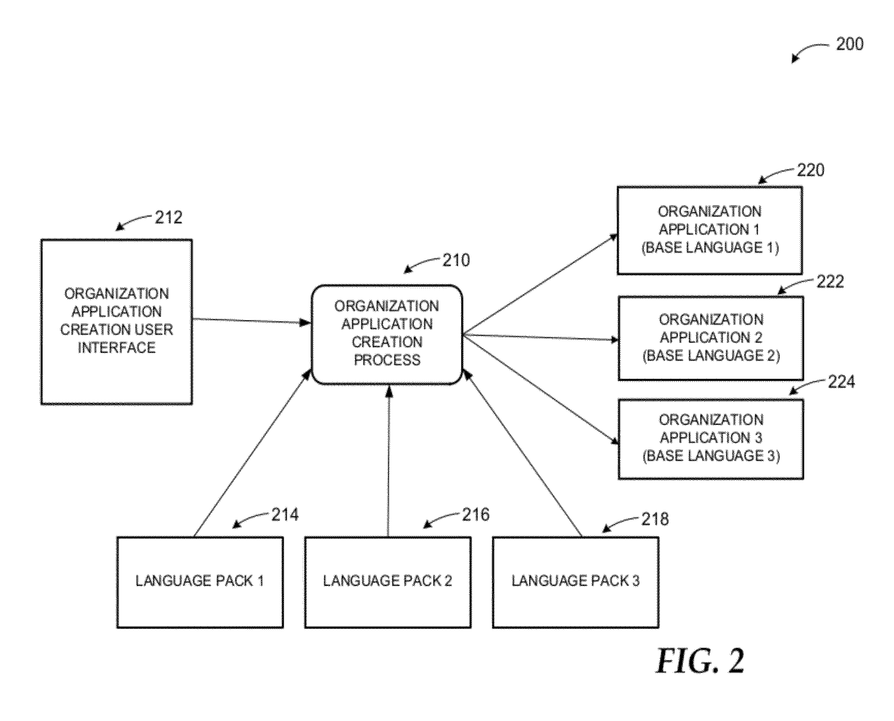

FIG. 2 illustrates example actions and components for customizing language for an organization application. Diagram 200 shows an organization application creation process 210. As previously discussed, the organization application may be a customized application tailored to meet business demands such as an inventory tracking application, sales monitoring application, report generation application, and comparable ones. An application manager may install and configure the organization application remotely or at customer location.

An application manager such as a CRM application may provide an installer (i.e.: a user with a security privilege to install an organization application) an organization application creation user interface (UI) 212. The installer may select a language from an available list of languages provided by the CRM application UI. The default language may be listed from any one of language packs 1, 2, and 3 (214, 216, and 218). The CRM application rules may limit an installer's access to a language pack. In an example scenario, an installer in a specific world region may only have access to language pack 1 (214) serving the language demands of that specific world region.

In an example embodiment, the organization application creation process 210 may create a first organization application 220 upon detecting a selection for a language. Alternatively, multiple organization applications may be created using different base languages such as second and third organization applications 222 and 224. The installer may choose to create an organization application for each language necessary to serve application needs of the business.

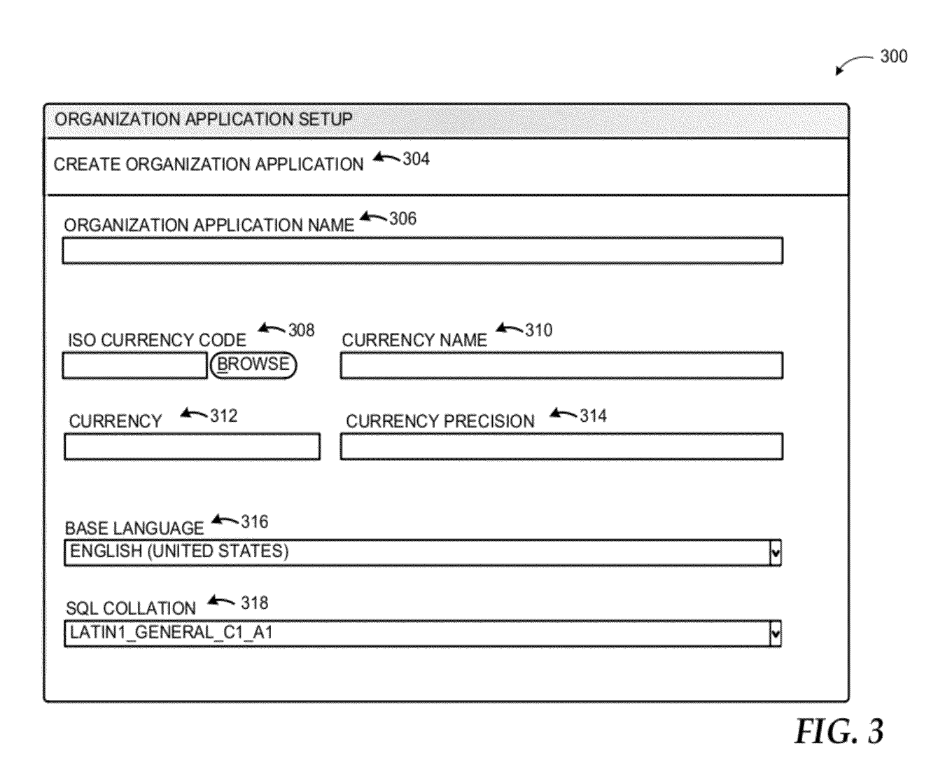

FIG. 3 illustrates a screenshot of an example interface. User interface (UI) 300 may display a functionality description 304 to inform the installer such as creating an organization application or editing/configuring an existing one. The installer may provide the organization application name 306 to identify the organization application.

In an example embodiment, the installer may provide application specific settings such as currency information during installation. The installer may specify a currency code 308 to be used in the organization application by either browsing a standardized currency code list such as an ISO currency code list or manually inputting the currency code into a text box. The installer may also provide other identifiers for currency such as currency name 310. The CRM application may also enable the installer to provide specific details for currency settings such as a description for the currency 312 and precision value for the currency 314. Tailored inputs for language units are not limited to currency but may also be provided for measurement units and other similar language specific components needing additional formatting.

The CRM application may provide the installer a base language selection using a drop down menu 316. Selection of a language may pair down available options to format organization application components through SQL collation drop down menu 318. The collation menu may provide formatting selections for organization application components such as sort order, menu locations, etc. according to the base language selection.

In an embodiment, an application manager may create a default organization application using a default language upon detecting a default base language selection from an initial installer. The default organization application may be used as settings provider for any subsequent organization application installation. A secondary installer may configure a second organization application using the settings of the default organization application. An example may be a CRM application providing an organization application setup UI to the secondary installer. The UI may be preloaded with settings inherited from the default organization application. Upon detecting a second base language selection from the secondary installer, the application manager may create the second organization application using the selected second base language.

In another embodiment, the secondary installer may or may not be the initial installer. Additionally, the secondary installer may lack the security privilege to install the default organization application due to business requirements. As discussed above, the application manager may retrieve the second language from a language pack available from the application manager or from an external resource such as an installation disk.

In yet another embodiment, customizing the language of the second organization application into the second base language may enable the second application organization to list security roles of users in the second base language. Additionally, the second organization application may label sort order list items, customized components such as data entry fields, and default components inherited from the default organization application in the second base language. Examples of customizing the second organization application or any other subsequent organization application installation with a base language is not limited to examples provided above but may be accomplished by other venues.

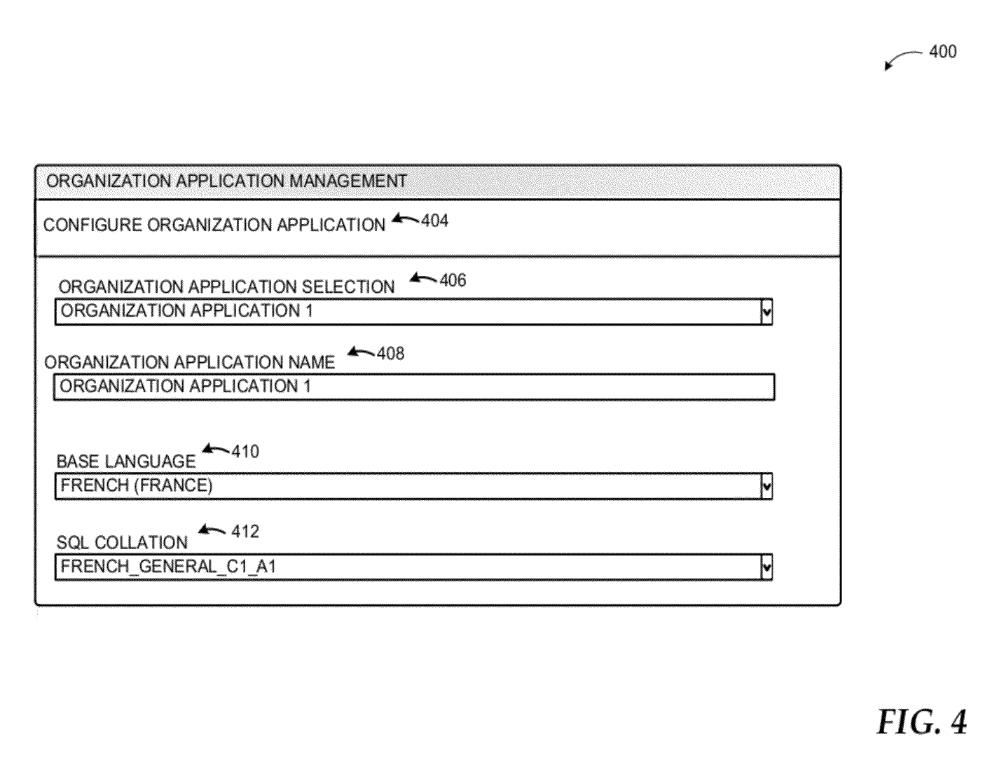

FIG. 4 illustrates another screenshot of an example interface configuring language for an organization application. As discussed above an organization application is a custom application tailored to meet business demands. The organization application may be installed by an application manager such as a CRM application.

Example UI 400 may be provided by the application manager to customize an installed organization application's base language. The application manager such as a CRM application may start configuring an organization application 404 upon detecting an organization selection from a drop down menu 406. The CRM UI 400 may also provide an installer with an ability to alter the name of the selected organization application 408. Additionally, the installer may also change the base language of the selected organization application by selecting a base language from a drop down menu 410. Selection of the base language may enable the installer to alter an SQL collation formatting option 412. SQL collation options may correspond to formatting styles for organization application components such as sort orders, etc.

In an embodiment, the CRM application providing installation as well as customization functionality for the organization application may be a local application within the business infrastructure. Alternatively, the CRM application may be provided remotely from an external entity as a hosted service.

In another embodiment, the CRM application may limit base language selection to a subset of available languages in a language pack according to a business policy. The business policy may define a world region serviced by the CRM application describing available languages to that region. Additionally, the CRM application may enable a user to extract any labels used to customize components of the organization application in a selected base language. The user may extract labels in order to translate the labels to other languages. Extraction of the labels may be by exporting the labels into an extensible markup language (XML) format file. The labels in an XML format may aid in migrating customized organization applications to upgraded platforms (i.e.: CRM application upgrades). The custom labels may be imported to other organization applications therefore restoring customized language features offered in the initial organization application.

In yet other embodiments, the CRM application may limit upgrading an organization application only if the CRM application (upgraded or not) detects the organization application language in an accessible language pack. Alternatively, a local CRM application deployed in a local business platform may be allowed to upgrade an organization application. Additionally, both a default organization application and a customized organization application may include customized currency metrics and currency format based on the selected base languages.

The example user interfaces in FIGS. 3 and 4 are shown with specific components, data types, and configurations. Embodiments are not limited to systems according to these example configurations. Customizing language for an organization application may be implemented in configurations employing fewer or additional components in applications and user interfaces. Furthermore, organization applications, language packs, and CRM application shown in FIG. 3 and 4 and their attributes may be implemented in a similar manner with other values using the principles described herein.

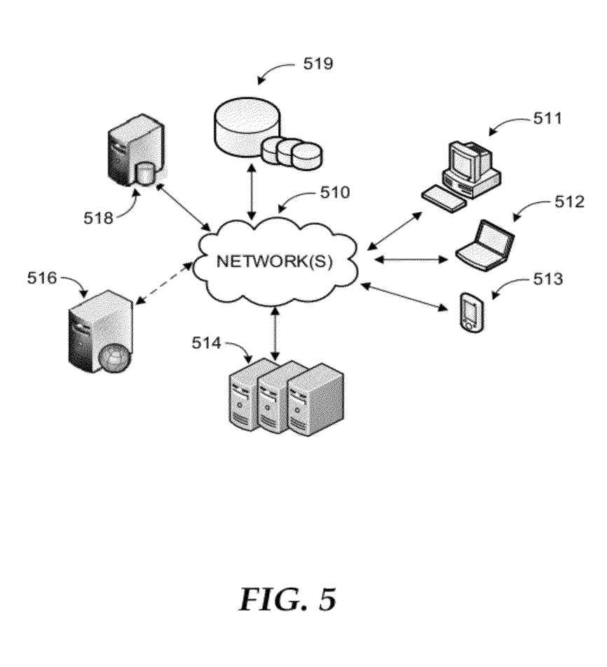

FIG. 5 is a networked environment, where a system according to embodiments may be implemented. Organization applications may be created by a CRM application executed over one or more servers 514 or a single server (e.g. web server) 516 such as a hosted service. The CRM application may communicate with client applications on individual computing devices such as a smart phone 513, a laptop computer 512, or desktop computer 511 ('client devices') through network(s) 510.

As discussed above, organization applications may be installed and configured with languages other than default. The CRM application may detect an installer selection of a base language and customize the organization application according to the selection.

Client devices 511-513 may enable access to applications executed on remote server(s) (e.g. one of servers 514) as discussed previously. The server(s) may retrieve or store relevant data from/to data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to customize language for an organization application. Furthermore, the networked environments discussed in FIG. 5 are for illustration purposes only. Embodiments are not limited to the example applications, modules, or processes.

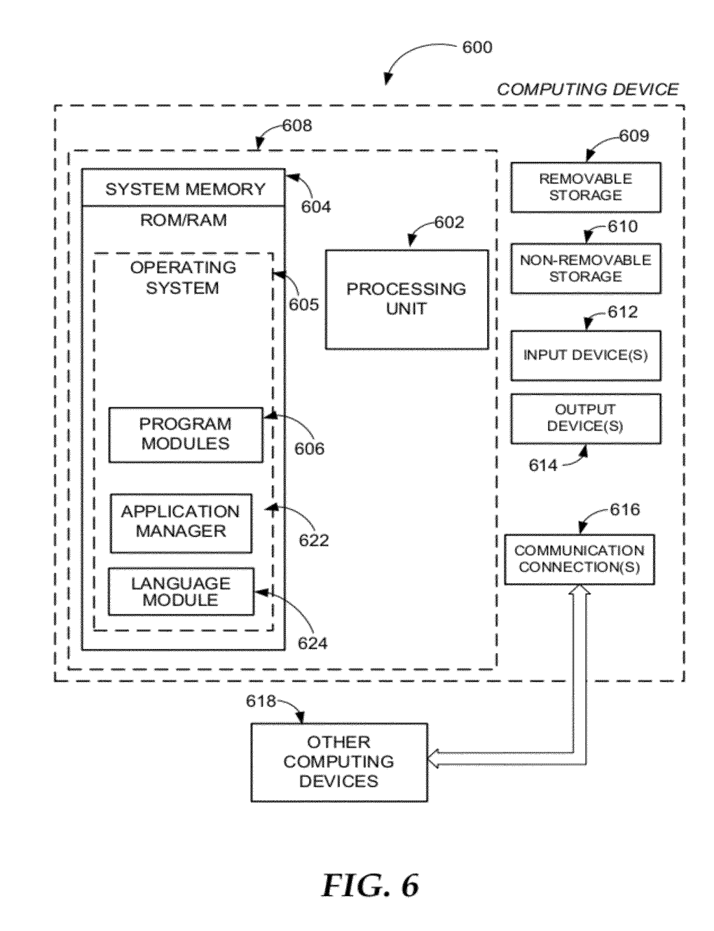

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® operating systems from MICROSOFT CORPORATION of Redmond, Wash. The system memory 604 may also include one or more software applications such as program modules 606, application manager 622, and language module 624.

Application manager 622 may be a CRM application customizing language for an organization application. The language module may determine language capabilities available to an organization application based on business policy such as regional restrictions. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. Computer readable storage media is a non-transitory computer readable memory device. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that execute communication applications, storage servers, and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

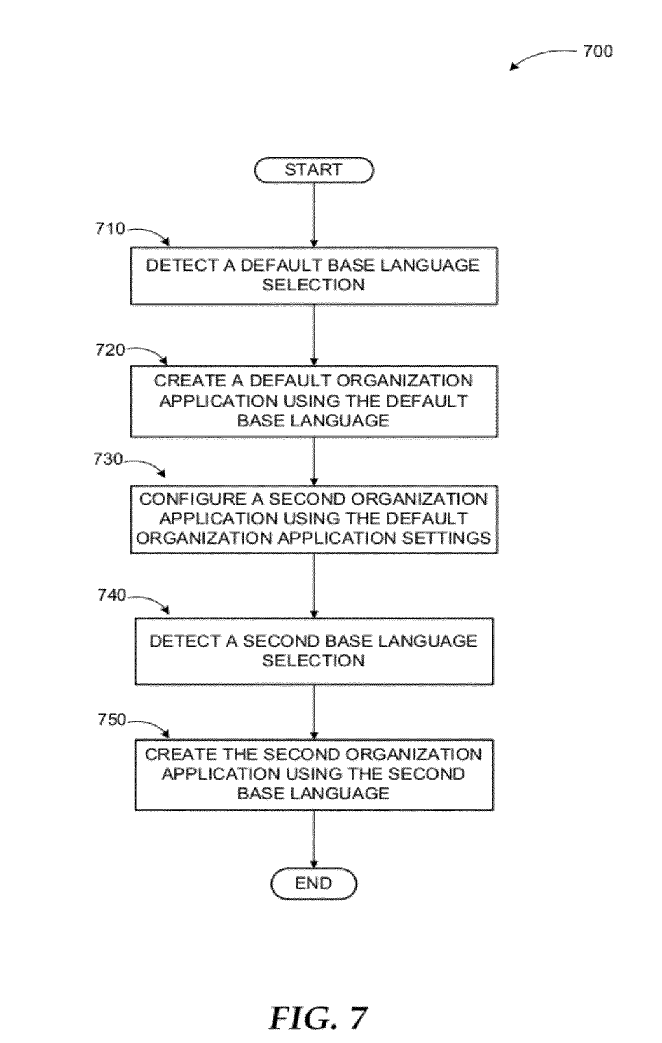

FIG. 7 illustrates a logic flow diagram for a process customizing language of an organization application according to embodiments. Process 700 may be implemented by a CRM application on any computing device.

Process 700 may begin with detecting a default base language selection at operation 710. A CRM application may create a default organization application using the default base language at operation 720. The CRM application may provide a UI to configure a second organization application using the default organization application settings at operation 730. Next, the CRM application may detect a second base language selection 740 and create the second base organization application using the second base language at operation 750 (i.e.: create an organization application using a language available to the world region served by the CRM application).

Some embodiments may be implemented in a computing device that includes a communication module, a memory, and a processor, where the processor executes a method as described above or comparable ones in conjunction with instructions stored in the memory. Other embodiments may be implemented as a computer readable storage medium with instructions stored thereon for executing a method as described above or similar ones.

The operations included in process 700 are for illustration purposes. Customizing language for an organization application may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for customizing language of an organization application by an application manager, the method comprising:
detecting a default base language selection from a first installer;
creating a default organization application using the selected default base language;
creating a second organization application based on settings of the default organization application;
detecting a second base language selection from a second installer; and
configuring the second organization application using the selected second base language.

2. The method of claim 1, wherein the second installer is different from the first installer.

3. The method of claim 2, wherein a set of available languages for the second base language selection are limited based on a security privilege of the second installer.

4. The method of claim 1, wherein the organization application is a custom application tailored to serve business demands.

5. The method of claim 1, further comprising:
retrieving the second base language selection from a language pack.

6. The method of claim 5, wherein the language pack is available from one of: the application manager and an external resource.

7. The method of claim 1, further comprising:
listing security roles for the second organization application in the second base language.

8. The method of claim 1, further comprising:
labeling a sort order of list items of the second organization application in the second base language.

9. The method of claim 1, further comprising:
labeling customized components of the second organization application in the second base language.

10. The method of claim 1, further comprising:
labeling default components inherited from the default organization application in the second base language.

11. A computing device for customizing language of an organization application by a customer relationship management (CRM) application, the computing device comprising:
a memory storing instructions; and
a processor coupled to the memory, the processor executing an application manager in conjunction with the instructions stored in the memory, wherein the application manager is adapted to:
detect a default base language selection from a first installer;
create a default organization application using the selected default base language;
create a second organization application using settings of the default organization application;
detect a second base language selection from a second installer;
configure the second organization application using the selected second base language; and
label a sort order of list items and customized components of the second organization application in the second base language.

12. The computing device of claim 11, wherein the application manager is provided as one of a locally installed application and a hosted service.

13. The computing device of claim 11, wherein the application manager is further adapted to:
limit the second base language selection to a subset of available languages in a language pack of the CRM application according to a business policy.

14. The computing device of claim 13, wherein the business policy defines a world region serviced by the CRM application and a list of corresponding languages available in the world region.

15. The computing device of claim 11, further adapted to:
extract labels for customized components in the second base language to translate the labels to other languages.

16. The computing device of claim 15, further adapted to:
export the labels into an extensible markup language (XML) format file for migration to another organization application; and
import the labels from the XML format file to customize the other organization application.

17. A computer-readable memory device with instructions stored thereon for customizing language of an organization application by a customer relationship management (CRM) application, the instructions comprising:
detecting a default base language selection from a first installer;
creating a default organization application using the selected default base language;
creating a second organization application using settings of the default organization application;
detecting a second base language selection from a second installer;
configuring the second organization application using the selected second base language; and
labeling default components inherited from the default organization application in the second base language.

18. The computer-readable memory device of claim 17, wherein the instructions further comprise:
upgrading the second organization application upon detecting the second base language in a language pack of the CRM application.

19. The computer-readable memory device of claim 18, wherein upgrading the second organization application is limited to a local CRM application.

20. The computer-readable memory device of claim 17, wherein the default and second base languages are selected based on an installer selection of a currency.
